(19) United States
(12) Patent Application Publication
(10) Pub. No.: US 2002/0052466 A1
(43) Pub. Date: May 2, 2002

(54) Process for reducing the chlorine content of low molecular weight isocyanates

(76) Inventors: Martin Brahm, Odenthal (DE); Karsten Danielmeier, Bethel Park, PA (US); Ralf Dohrn, Bergisch Gladbach (DE); Uwe Denninger, Bergisch Gladbach (DE); Gerd Brunner, Hamburg (DE); Andreas Bezold, Hamburg (DE)

Correspondence Address: BAYER CORPORATION, PATENT DEPARTMENT, 100 BAYER ROAD, PITTSBURGH, PA, 15205, US

(21) Appl. No.: 09/918,210

(22) Filed: Jul. 30, 2001

(30) Foreign Application Priority Data
Aug. 3, 2000 (DE) 10037772.6

(51) Int. Cl. C08J 3/00

(52) U.S. Cl. 528/491; 528/494

(57) ABSTRACT

The present invention relates to a process for purifying low molecular weight isocyanates or isocyanate mixtures from chlorine compounds by extractively treating the low molecular weight isocyanates or isocyanate mixtures with an extraction agent containing near-critical and/or super-critical fluids or fluid mixtures at a temperature of 10° C. to 200° C., a pressure of 10 bar to 1,000 bar and a weight ratio of the extraction agent to the isocyanate or isocyanate mixture of 1 to 200, and separating the chlorine compounds from the extraction agent by reduction in pressure.

### BACKGROUND OF THE INVENTION

1. Field of the Invention

The invention relates to a new process for purifying organic isocyanates or isocyanate mixtures from chlorine compounds by treating and extracting them with near-critical and/or super-critical fluids.

2. Description of the Prior Art

Production-induced impurities of various types and amounts in organic isocyanates influence their reactivity during further processing (for example variations in activity). Variations in activity of this type are unfavorable for repeatable, economic use. Aromatic isocyanates (for example, the known phosgenation products of aniline formaldehyde condensates or 2,4- and 2,6-diisocyanatotoluene) and aliphatic isocyanates (for example, isophorone diisocyanate) contain many impurities of this type, in particular, chlorine-containing compounds. They always cause variations in activity if hydrolyzable (very mobile) chlorine is involved. Some of these compounds, however, prove relatively stable and remain in the isocyanates even after distillation, and this, apart from activity, also unfavorably influences the stability and color of the isocyanates. A uniform small proportion of these impurities in isocyanates is both technically and economically significant as it ensures a certain reactivity (standardization of activity) and easy further processing.

There have been many attempts to find ways of removing the chlorine-containing compounds from isocyanates. A wide variety of processes are listed in a large number of publications including thermal processes, methods such as inert gas stripping or processes which use special crystallization methods. Effective separation of the undesirable chlorine compounds is not achieved by any of these processes which are on a purely physical treatment, as only easily cleavable chlorine compounds can be decomposed and separated off thereby. The use of processes of this type is therefore limited to specific, generally thermally stable, isocyanate compounds, in which a low residual chlorine content does not interfere with the use thereof.

Processes are also described in which attempts are made to reduce the proportion of hydrolyzable chlorine compounds by chemical additives. Metals, metal salts and a plurality of organic compounds, for example, amines are used in this process.

However, it is disadvantageous that all of these processes contribute to the contamination of the purified isocyanate due to the presence chemical additives, which adversely affect properties such as storage stability, reactivity and toxicology. Many additives, such as amines, acids and metal salts, are also known catalysts in isocyanate chemistry and thus accelerate undesired side reactions. High temperatures usually have to be used over a prolonged period, in addition to these additives, for complete separation of chlorine compounds. However, high temperatures lead to strong discoloration and also to undesirable by-products, which have to be carefully separated off and disposed of in laborious steps.

It is therefore an object of the present invention to provide a universally usable process for purifying organic low molecular weight isocyanates, in particular temperature-sensitive low molecular weight isocyanates that provides efficient separation of hydrolyzable chlorine compounds from isocyanates without additives and/or lengthy thermal treatment at high temperatures,

This object may be achieved with the process according to the invention described in more detail hereinafter, in which the chlorine compounds are separated from the isocyanate compounds by treatment and extraction with near-critical and super-critical fluids.

### SUMMARY OF THE INVENTION

The present invention relates to a process for purifying low molecular weight isocyanates or isocyanate mixtures from chlorine compounds by extractively treating the low molecular weight isocyanates or isocyanate mixtures with an extraction agent containing near-critical and/or super-critical fluids or fluid mixtures at a temperature of 10° C. to 200° C., a pressure of 10 bar to 1,000 bar and a weight ratio of the extraction agent to the isocyanate or isocyanate mixture of 1 to 200, and separating the chlorine compounds from the extraction agent by reduction in pressure.

### DETAILED DESCRIPTION OF THE INVENTION

In the process according to the invention the hydrolyzable chlorine compounds can be separated off as an extract or raffinate. The resulting isocyanates or isocyanate mixtures have a hydrolyzable chlorine compound content (HC-containing component) of less than 100 ppm, preferably less than 10 ppm.

There are a plurality of methods in the literature which explain in more detail the treatment of isocyanates with super-critical carbon dioxide. Thus, for example, DE-A 19 616 046, DE-A-19 541 557, U.S. Pat. No. 5,917,011, EP-A 309 364, EP-A 337 898, EP-A 273 836, JP-A 63 087 977 and EP-A 263 044 describe processes for liberating polymers that may contain free isocyanate groups from monomeric diisocyanates, i.e. low molecular weight compounds. The existing solubility properties, which differ due to the different molecular weights, are used to achieve separation.

The separation according to the invention of low molecular weight chlorine-containing compounds from low molecular weight compounds also containing isocyanate groups has not yet been described.

Surprisingly, it is possible with the process according to the invention to separate isocyanate group-containing compounds from chlorine-containing compounds in a simple manner by extraction with super-critical fluids even if both types of compounds have a similar structure or a similar or identical molecular weight. The process according to the invention allows purification of compounds containing any isocyanate groups without thermal or catalytically induced by-product formation.

The starting materials for the process according to the invention are low molecular weight isocyanates or mixtures of low molecular weight isocyanates. Examples of low molecular weight isocyanates include

a) monoisocyanates with aliphatically, cycloaliphatically, araliphatically or aromatically bound isocyanate groups such as butyl isocyanate, hexyl isocyanate, octyl isocyanate, stearyl isocyanate, cyclohexyl isocyanate, benzyl isocyanate, 2-phenylethyl isocyanate, phenyl isocyanate and mixtures of monoisocyanates of this type;

b) diisocyanates having a molecular weight of 140 to 400 with aliphatically, cycloaliphatically, araliphatically and/or aromatically bound isocyanate groups, for example, 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis-(isocyanatomethyl)cyclohexane, 1-isocyanato-3,3,5-trimethyl-5-isocyanatomethyl-cyclohexane (isophoronediisocyanate, IPDI), 4,4′-diisocyanato-dicyclohexylmethane, 1-isocyanato-1-methyl-4(3)isocyanatomethyl-cyclohexane (IMCI), bis-(isocyanatomethyl)-norbornane, 2-methyl-pentane-2,4-diisocyanate, 1,3- and 1,4-bis-(2-isocyanatoprop-2-yl)-benzene (TMXDI), 2,4- and 2,6-diisocyanatotoluene (TDI), 2,4′- and 4,4′-diisocyanatodiphenylmethane, 1,5-diisocyanaton-aphthalene and dipropyleneglycoldiisocyanate, and

c) triisocyanates and/or higher-functional isocyanates such as 4-isocyanatomethyl-1,8-octanediisocyanate (nonanetriisocyanate), 1,6,11-undecanoictriisocyanate and mixtures of isocyanates of this type.

In general, organic isocyanates having a molecular weight up to about 800, preferably 99 to 279 g/mol can be used as low molecular weight isocyanates.

Di- and higher-functional isocyanates are preferably used in the process according to the invention. 4-isocyanatomethyl-1,8-octanediisocyanate (nonanetriisocyanate) is especially preferred.

In accordance with the process of the invention the organic isocyanate is conveyed from a receiving vessel via a heat exchanger into an extraction vessel (pressure vessel, preferably a rectifying column) through which a near-critical or super-critical fluid flows. The HC-containing components are enriched in the gaseous phase. The gaseous phase is removed from the extraction vessel and liberated from the dissolved components in a separation vessel. This can take place by pressure reduction, absorption, adsorption or with the aid of a membrane. Some of the separated fluid is optionally recompressed and returned into the top of the rectifying column, corresponding to a backflow in the fortifying part of a distillation column. The near- or super-critical fluid is recompressed and returned into the extraction vessel once it has left the separation vessel. The organic isocyanate is removed from the bottom of the pressure vessel and expanded to normal pressure once it has been liberated from the HC-containing components. The near- or super-critical fluid escapes in this process.

Feeding of the mixture to be purified and the extraction agent and removal of the loaded extraction agents and of the purified mixture can be carried out continuously or discontinuously. Extraction is preferably carried out continuously.

In a further variation of the process according to the invention, a depletion of the HC-containing components is achieved in the gaseous phase by selecting suitable plant parameters, such as pressure, temperature and fluid composition. This procedure allows the purified isocyanate component to be removed as an extract and the HC-containing components to be sluiced out in the raffinate.

Extraction with the near- and/or super-critical fluid (mixtures) is carried out at temperatures from 10° C. to 200° C., preferably at 40° C. to 80° C. and at pressures from 10 bar to 1,000 bar, preferably at 80 bar to 200 bar. The solvent ratio (extraction agent/crude product) in the process according to the invention is 1 to 200, preferably 5 to 100 and more preferably 10 to 50.

Suitable extraction agents are basically fluids or fluid mixtures that are not capable of reacting with isocyanates and are near- or super-critical under the process conditions. Carbon dioxide, dinitrogen monoxide, dimethyl ether and saturated and/or unsaturated hydrocarbons up to a chain length of 5 carbon atoms are preferably used as extraction agents. Methane, ethane, propane, cyclopropane, butane, cyclobutane, isobutane, pentane, iso-pentanes and cyclopentane are examples of suitable saturated hydrocarbons with 1 to 5 carbon atoms.

Ethylene, propene, butene-1, butene-2; pentene-1, iso-pentenes and cyclopentene are examples of suitable unsaturated hydrocarbons with 2 to 5 carbon atoms.

Carbon dioxide and mixtures of carbon dioxide with the other described extraction agents having a carbon dioxide content of at least 50 wt. % are especially preferred.

According to the invention, near-critical is taken to mean conditions at which the temperature corresponds to at least 0.8 of the absolute critical temperature and in which the pressure corresponds to at least the vapor pressure at the extraction temperature.

Extraction can be single-stage or multistage in which the extraction agent is circulated. Multistage extraction can, for example, be carried out in a rectifying column or in a multistage mixer-separator battery.

Before or after the reduction of the chlorine content in isocyanates or mixtures thereof by the process according to the invention, other purification methods for isocyanates can also be used, for example, to remove coloring components and by-products. These include brightening, for example, with reducing or oxidising agents and treatment with adsorption agents such as activated carbon and/or silica. Brightening can additionally have a positive effect on the reduction of the chlorine content of the isocyanate compound.

Isocyanates purified according to the invention no longer require additions of metal compounds, acids, bases or compounds capable of reacting with isocyanates. They can be universally used for producing intermediates, polyurethane molded parts and coating compositions. The low molecular weight isocyanates purified by the process according to the invention are preferably used as a curing component in binder mixtures for producing coatings.

Binder mixtures which contain isocyanates purified by the method according to the invention are suitable for coating any substrates such as wood, plastics, leather, paper, textiles, glass, ceramics, plaster, stone, masonry, metals or concrete. They can be applied by conventional application methods such as spraying, brushing, flooding, casting, dipping, rolling. The binder mixtures can contain pigments or can be used for producing varnishes. They can be thinned in organic solvents, dispersed in water or may remain unthinned, and may be used as one-component or multicomponent coating compositions.

### EXAMPLES

The HC values given relate to the hydrolyzable chlorine content.

### Example 1

A pressure vessel with a volume of 1,200 ml was filled with 600 g of crude 4-isocyanatomethyl-1,8-octanediisocyanate having an HC value of 2070 ppm. The temperature was adjusted to 40° C. Carbon dioxide (Linde AG with a purity of 99.995 vol. % and a water content of below 5 vpm) was added while stirring, until a constant pressure of 100 bar was obtained. A sample was taken from the gaseous phase and the carbon dioxide separated from the dissolved components. The separated fluid had an HC value of 3218 ppm with which a significant enrichment of the HC value in the extract or a depletion in the raffinate was achieved in a theoretical separation stage. 992 mg CO₂ and 8 mg of dissolved components were obtained in 1,000 mg of the gaseous phase under the investigated conditions. When the carbon dioxide was allowed to flow through the pressure vessel at a quantitative rate of flow of 10.1 kg/h under constant pressure and temperature conditions, the HC value of the raffinate (isocyanate) dropped to 850 ppm after 4 h.

When the density of the carbon dioxide was increased by means of a pressure increase or a temperature reduction, the loading of the gaseous phase increased, for example to 59 mg of dissolved components at 250 bar and 60° C.; the HC value was 2272 ppm. When the carbon dioxide was allowed to flow through the pressure vessel at a quantitative rate of flow of 9.97 kg/h under constant pressure and temperature conditions, the HC value of the raffinate (isocyanate) decreased to 891 ppm after only 53 min.

### Example 2

A pressure vessel with a volume of 1,200 ml was filled with 600 g of crude 4-isocyanatomethyl-1,8-octanediisocyanate having an HC value of 920 ppm. The temperature was adjusted to 60° C. Carbon dioxide (Linde AG with a purity of 99.995 vol. % and a water content of below 5 vpm) was added while stirring, until a constant pressure of 150 bar was obtained. When a sample was taken from the gaseous phase and the carbon dioxide separated from the dissolved components, the separated fluid had an HC value of 2567 ppm. 991 mg CO₂ and 9 mg of dissolved components were obtained in 1,000 mg of the gaseous phase under the investigated conditions. When carbon dioxide was allowed to flow through the pressure vessel at a quantitative rate of flow of 10.12 kg/h under constant pressure and temperature conditions, the HC value of the raffinate (isocyanate) decreased to 410 ppm after only 96 min.

With an increase in the density of the carbon dioxide due to a pressure increase or a temperature reduction, the load of the gaseous phase increased, for example, to 29 mg of dissolved components at 200 bar and 60° C., the HC value being 1718 ppm. If carbon dioxide is allowed to flow through the pressure vessel with a quantitative rate of flow of 10.11 kg/h under constant pressure and temperature conditions, the HC value of the raffinate (isocyanate) reduces to 85 ppm after only 80 min.

### Example 3

A rectifying column with a diameter of 25 mm, filled with a Sulzer EX gauze packing was heated to a temperature of 60° C. and filled with carbon dioxide to a pressure of 150 bar. Circulation of CO₂ to a separation vessel, recompression of the CO₂ and a return of the recompressed CO₂ into the rectifying column was adjusted; the quantitative rate of flow was 10.14 kg/h. The feed material (crude 4-isocyanatomethyl-1,8-octanediisocyanate with an HC value of 2093 ppm) was fed with an HPLC pump to the top of the column under constant extraction conditions. Once draining raffinate could be established through a viewing window in the sump of the column, the sump of the column and the separator were emptied and the test was run for 3 hours with constant mass flows. At an inflow of 193 g/h, an extract flow of 72 g/h and a raffinate flow of 121 g/h were produced, calculated in each case on a CO₂-free basis. The raffinate (isocyanate) had an HC value of 1223 ppm and the extract had an HC value of 2634 ppm.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for purifying a low molecular weight isocyanate or isocyanate mixture from chlorine compounds which comprises extractively treating the low molecular weight isocyanate or isocyanate mixture with an extraction agent comprising a near-critical and/or super-critical fluid or fluid mixture at a temperature of 10° C. to 200° C., a pressure of 10 bar to 1000 bar and a weight ratio of the extraction agent to the isocyanate or isocyanate mixture of 1 to 200 and separating off the chlorine compounds from the extracting agent by reducing the pressure.

2. The process of claim 1 which comprises separating off the hydrolyzable chlorine compounds as an extract.

3. The process of claim 1 which comprises separating off the hydrolyzable chlorine compounds as a raffinate.

4. The process of claim 1 which comprises using carbon dioxide as the extraction agent.

5. The process of claim 1 which comprises using nitrogen dioxide as the extraction agent.

6. The process of claim 1 which comprises using dimethyl ether as the extraction agent.

7. The process of claim 1 which comprises using saturated and/or unsaturated hydrocarbons as the extraction agent.

8. The process of claim 1 wherein the extraction agent contains at least 50 wt. % carbon dioxide.

9. An isocyanate or isocyanate mixture obtained according to the process of claim 1 and having a hydrolyzable chlorine compound content of less than 100 ppm.

10. A polyurethane molded part or a polyurethane coating prepared from the purified isocyanate of claim 9.
